(19) United States
(12) Patent Application Publication
(10) Pub. No.: US 2025/0316415 A1
(43) Pub. Date: Oct. 9, 2025

(54) INDUCTOR STRUCTURE AND MANUFACTURING METHOD THEREOF

(71) Applicant: PHOENIX PIONEER TECHNOLOGY CO., LTD., Hsinchu County (TW)

(72) Inventors: Pao-Hung CHOU, Hsinchu County (TW); Shih-Ping HSU, Hsinchu County (TW)

(21) Appl. No.: 19/094,930

(22) Filed: Mar. 30, 2025

(30) Foreign Application Priority Data
Apr. 3, 2024 (TW) 113112775

(51) Int. Cl. H01F 27/28; H01F 41/04

(52) U.S. Cl. CPC H01F 27/2804; H01F 41/041; H01F 2027/2809

(57) ABSTRACT

An inductor structure is provided and includes a bottom element, at least one intermediate element and a top element. The bottom element includes a first inductance circuit portion. The intermediate element is stacked on the bottom element and includes at least one second inductance circuit portion and at least one magnetically permeable body. The top element is stacked on the intermediate element and includes a third inductance circuit portion. The first inductance circuit portion, the second inductance circuit portion and the third inductance circuit portion constitute an inductance coil, and the magnetically permeable body is located within the inductance coil and is free from being electrically connected to the inductance coil. A method of manufacturing the inductor structure is further provided.

### BACKGROUND

### 1. Technical Field

The present disclosure relates to an inductor, and more particularly, to a modular inductor structure which can be used as a separating element, an electrical device, or a semiconductor package element, and to a method of manufacturing the same.

### 2. Description of Related Art

General semiconductor application devices, such as communication or high-frequency semiconductor devices, often need to electrically connect most of the radio-frequency passive elements such as resistors, inductors, capacitors and oscillators to the packaged semiconductor chip, so that the semiconductor chip has a specific current characteristic or emits a signal. For example, there are many types of conventional inductors, which are mostly used to suppress power supply noise.

At present, the semiconductor industry is aiming at light, thin and small electronic equipment, and it is mainly to develop a single element towards miniaturization or thinning. In a semiconductor package 1 shown in FIG. 1A and FIG. 1B, a coil-type inductor 12 is integrated on a package substrate 10 having a circuit layer 11, a semiconductor chip 13 is arranged on the package substrate 10, and the semiconductor chip 13 is electrically connected to electrode pads 110 of the circuit layer 11 via a plurality of bonding wires 130, wherein sputtering and vapor deposition techniques can be used to produce a thinner metal film to form the coil-type inductor 12, that is, a thin film inductor.

However, the coil-type inductor 12 is disposed on the package substrate 10, so that the inductance value generated by the coil-type inductor 12 is too small to meet the requirement. To increase the inductance value, it is necessary to increase the area or volume of the coil-type inductor 12, such that the semiconductor package 1 cannot meet the needs of products such as miniaturization, thinness, lightness and shortness, and it is difficult to design the coil-type inductor 12 under the demand for different inductance values.

In addition, the industry has even used the semiconductor package board build-up process to manufacture inductors or package structures. However, due to the characteristics of the process, the layers must be added one by one, such that the overall process time is lengthy, and there is a risk that the entire set must be scrapped or remanufactured due to defects in the build-up layers in the middle of the process, thereby seriously affecting the production efficiency and cost.

Therefore, how to overcome various problems of the above-mentioned prior art has become a difficult problem urgently to be overcome in the industry.

### SUMMARY

In view of the various deficiencies of the prior art, the present disclosure provides a modular structural design and corresponding process to separately manufacture each of module components, and to flexibly assemble the module components that are all good products according to the terminal demand, thereby meeting the demands of various different Q values (where Q stands for quality or quality factor) and inductance values, avoiding process losses and significantly reducing the manufacturing time and cost.

The present disclosure provides an inductor structure, which comprises: a bottom element including a first circuit structure and a first inductance circuit portion disposed on the first circuit structure; at least one intermediate element stacked on the bottom element and including at least one second inductance circuit portion and at least one magnetically permeable body, wherein the second inductance circuit portion is electrically connected to the first inductance circuit portion; and a top element stacked on the intermediate element and including a third inductance circuit portion and a second circuit structure disposed on the third inductance circuit portion, wherein the third inductance circuit portion is electrically connected to the second inductance circuit portion, wherein a plurality of first conductive structures are bonded between the first inductance circuit portion and the second inductance circuit portion, the second inductance circuit portion is electrically connected to the first inductance circuit portion by the plurality of first conductive structures, a plurality of second conductive structures are interposed between the second inductance circuit portion and the third inductance circuit portion, the third inductance circuit portion is electrically connected to the second inductance circuit portion by the plurality of second conductive structures, the first inductance circuit portion, the second inductance circuit portion and the third inductance circuit portion constitute an inductance coil, and the magnetically permeable body is located within the inductance coil and is free from being electrically connected to the inductance coil, the first circuit structure and the second circuit structure.

In the aforementioned inductor structure, each of the plurality of first conductive structures is a first conductive bump, and each of the plurality of second conductive structures is a second conductive bump.

In the aforementioned inductor structure, the first conductive bump and the second conductive bump are copper paste bumps, tin paste bumps, or silver paste bumps.

In the aforementioned inductor structure, each of the plurality of first conductive structures has a first male member and a first female member that is matched with the first male member, one of the first male member and the first female member is bonded with the first inductance circuit portion, the other one of the first male member and the first female member is bonded with the second inductance circuit portion, each of the plurality of second conductive structures has a second male member and a second female member that is matched with the second male member, one of the second male member and the second female member is bonded with the second inductance circuit portion, and the other one of the second male member and the second female member is bonded with the third inductance circuit portion.

In the aforementioned inductor structure, the first male member and the second male member are copper pillars or tin pillars, and the first female member and the second female member are copper rings or tin rings.

In the aforementioned inductor structure, the present disclosure further comprises an insulating adhesive film disposed between the bottom element and the intermediate element and disposed between the intermediate element and the top element, wherein the insulating adhesive film has a plurality of vias to accommodate the plurality of first conductive structures and the plurality of second conductive structures.

In the aforementioned inductor structure, each of the plurality of first conductive structures has a first conductive pillar and a first conductor that is matched with the first conductive pillar, one of the first conductive pillar and the first conductor is bonded with the first inductance circuit portion, the other one of the first conductive pillar and the first conductor is bonded with the second inductance circuit portion, each of the plurality of second conductive structures has a second conductive pillar and a second conductor that is matched with the second conductive pillar, one of the second conductive pillar and the second conductor is bonded with the second inductance circuit portion, and the other one of the second conductive pillar and the second conductor is bonded with the third inductance circuit portion.

In the aforementioned inductor structure, the first conductive pillar and the second conductive pillar are copper pillars or tin pillars, and the first conductor and the second conductor are anisotropic conductive films, anisotropic conductive paste bumps, copper paste bumps, tin paste bumps, or silver paste bumps.

In the aforementioned inductor structure, the magnetically permeable body is structured in a single layer or in multiple layers in a separated stack.

In the aforementioned inductor structure, the inductance coil is a toroidal solenoid coil, a solenoid coil, or a planar spiral coil.

In the aforementioned inductor structure, the present disclosure further comprises an electronic element disposed on the second circuit structure.

In the aforementioned inductor structure, the present disclosure further comprises a package layer formed on the bottom element and covering the intermediate element, the top element and the electronic element.

The present disclosure further provides a method of manufacturing an inductor structure. The method comprises: providing a bottom element, wherein the bottom element includes a first circuit structure and a first inductance circuit portion disposed on the first circuit structure; stacking and bonding on intermediate element on the bottom element, wherein the intermediate element includes at least one second inductance circuit portion and at least one magnetically permeable body, and the second inductance circuit portion is electrically connected to the first inductance circuit portion; and stacking and bonding a top element on the intermediate element, wherein the top element includes a third inductance circuit portion and a second circuit structure disposed on the third inductance circuit portion, the third inductance circuit portion is electrically connected to the second inductance circuit portion, the first inductance circuit portion, the second inductance circuit portion and the third inductance circuit portion constitute an inductance coil, and the magnetically permeable body is located within the inductance coil and is free from being electrically connected to the inductance coil, the first circuit structure and the second circuit structure.

In the aforementioned manufacturing method of the inductor structure, the present disclosure further comprises forming a plurality of first conductive bumps between the first inductance circuit portion and the second inductance circuit portion, wherein the second inductance circuit portion is electrically connected to the first inductance circuit portion by the plurality of first conductive bumps; and forming a plurality of second conductive bumps between the second inductance circuit portion and the third inductance circuit portion, wherein the third inductance circuit portion is electrically connected to the second inductance circuit portion by the plurality of second conductive bumps.

In the aforementioned manufacturing method of the inductor structure, the plurality of first conductive bumps and the plurality of second conductive bumps are copper paste bumps, tin paste bumps, or silver paste bumps formed by coating, dispensing, or printing.

In the aforementioned manufacturing method of the inductor structure, the present disclosure further comprises forming an insulating adhesive film between the first inductance circuit portion and the second inductance circuit portion and between the second inductance circuit portion and the third inductance circuit portion, wherein a plurality of first conductive structures are provided between the first inductance circuit portion and the second inductance circuit portion, the second inductance circuit portion is electrically connected to the first inductance circuit portion by the plurality of first conductive structures, a plurality of second conductive structures are provided between the second inductance circuit portion and the third inductance circuit portion, and the third inductance circuit portion is electrically connected to the second inductance circuit portion by the plurality of second conductive structures, wherein the insulating adhesive film has a plurality of vias to accommodate the plurality of first conductive structures and the plurality of second conductive structures respectively.

In the aforementioned manufacturing method of the inductor structure, each of the plurality of first conductive structures has a first male member and a first female member that is matched with the first male member, one of the first male member and the first female member is provided on the first inductance circuit portion, the other one of the first male member and the first female member is provided on the second inductance circuit portion, each of the plurality of second conductive structures has a second male member and a second female member that is matched with the second male member, one of the second male member and the second female member is provided on the second inductance circuit portion, and the other one of the second male member and the second female member is provided on the third inductance circuit portion.

In the aforementioned manufacturing method of the inductor structure, the first male member and the second male member are copper pillars or tin pillars, and the first female member and the second female member are copper rings or tin rings.

In the aforementioned manufacturing method of the inductor structure, the present disclosure further comprises forming a plurality of first conductors between the bottom element and the intermediate element; and forming a plurality of second conductors between the intermediate element and the top element, wherein a bottom surface of the second inductance circuit portion or a top surface of the first inductance circuit portion has a plurality of first conductive pillars that are matched with the plurality of first conductors, and a bottom surface of the third inductance circuit portion or a top surface of the second inductance circuit portion has a plurality of second conductive pillars that are matched with the plurality of second conductors.

In the aforementioned manufacturing method of the inductor structure, the plurality of first conductors and the plurality of second conductors are laminated anisotropic conductive films, or the plurality of first conductors and the plurality of second conductors are anisotropic conductive paste bumps, copper paste bumps, tin paste bumps, or silver paste bumps formed by coating, dispensing, or printing, and the plurality of first conductive pillars and the plurality of second conductive pillars are copper pillars or tin pillars.

In the aforementioned manufacturing method of the inductor structure, the magnetically permeable body is structured in a single layer or in multiple layers in a separated stack.

In the aforementioned manufacturing method of the inductor structure, the inductance coil is a toroidal solenoid coil, a solenoid coil, or a planar spiral coil.

In the aforementioned manufacturing method of the inductor structure, the present disclosure further comprises disposing at least one electronic element on the second circuit structure.

In the aforementioned manufacturing method of the inductor structure, the present disclosure further comprises forming a package layer on the bottom element to cover the intermediate element, the top element and the electronic element.

In summary, in the inductor structure of the present disclosure and manufacturing method thereof, the inductor structure can be divided into a bottom element, an intermediate element and a top element. Each of these elements can be separately manufactured by the carrier board process, or even by different production lines, so as to easily carry out mass production of large boards, and then the bottom element, the intermediate element and the top element can be combined by the stacking and packaging manner to accomplish a complete inductor structure that can meet different inductance values, Q values (where Q stands for quality or quality factor) and other terminal requirements. Therefore, the inductor structure of the present disclosure and the manufacturing method thereof can easily meet the requirements of different inductance values and Q values by assembling and stacking, and the manufacturing time and cost can be effectively shortened and reduced.

### BRIEF DESCRIPTION OF THE DRAWINGS

FIG. 1A is a schematic cross-sectional view of a conventional semiconductor package.

FIG. 1B is a schematic partial three-dimensional view of FIG. 1A.

FIG. 2A, FIG. 2B-1, FIG. 2C and FIG. 2D are schematic cross-sectional views illustrating a manufacturing method of an inductor structure according to a first embodiment of the present disclosure.

FIG. 2B-2 is a schematic cross-sectional view of another embodiment of FIG. 2B-1.

FIG. 3A, FIG. 3B and FIG. 3C are schematic cross-sectional views illustrating a manufacturing method of an inductor structure according to a second embodiment of the present disclosure.

FIG. 4A-1, FIG. 4B-1 and FIG. 4C-1 are schematic cross-sectional views illustrating a manufacturing method of an inductor structure according to a third embodiment of the present disclosure.

FIG. 4A-2, FIG. 4B-2 and FIG. 4C-2 are schematic cross-sectional views of another embodiment of FIG. 4A-1, FIG. 4B-1 and FIG. 4C-1.

FIG. 5 is a schematic cross-sectional view of an inductor structure according to a fourth embodiment of the present disclosure.

### DETAILED DESCRIPTION

The following describes the implementation of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “on,” “first,” “second,” “third,” “a,” “one,” “at least one” and the like used herein are merely used for clear explanation rather than limiting the practicable scope of the present disclosure, and thus, alterations or adjustments of the relative relationships thereof without essentially altering the technical contents should still be considered in the practicable scope of the present disclosure.

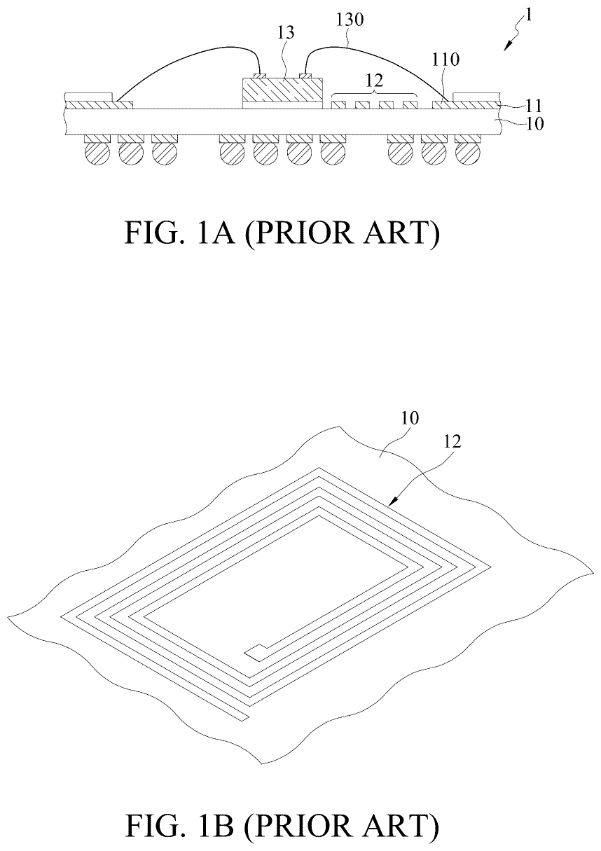

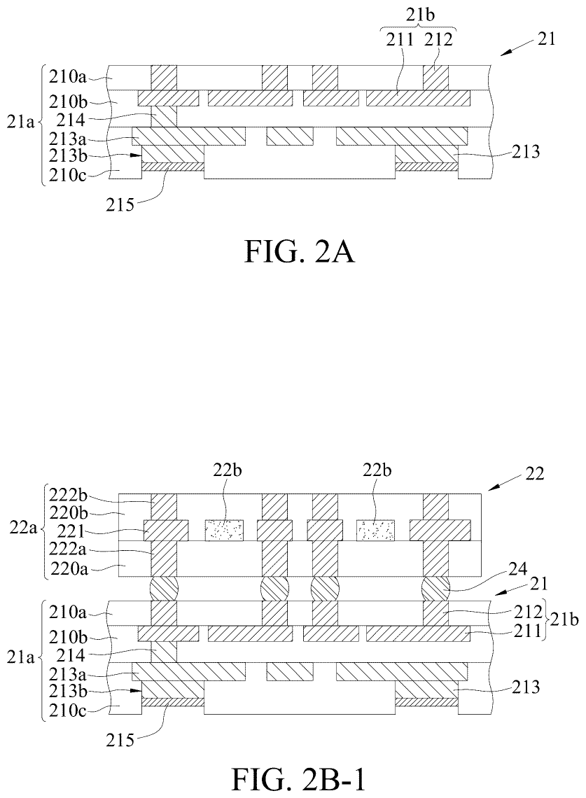

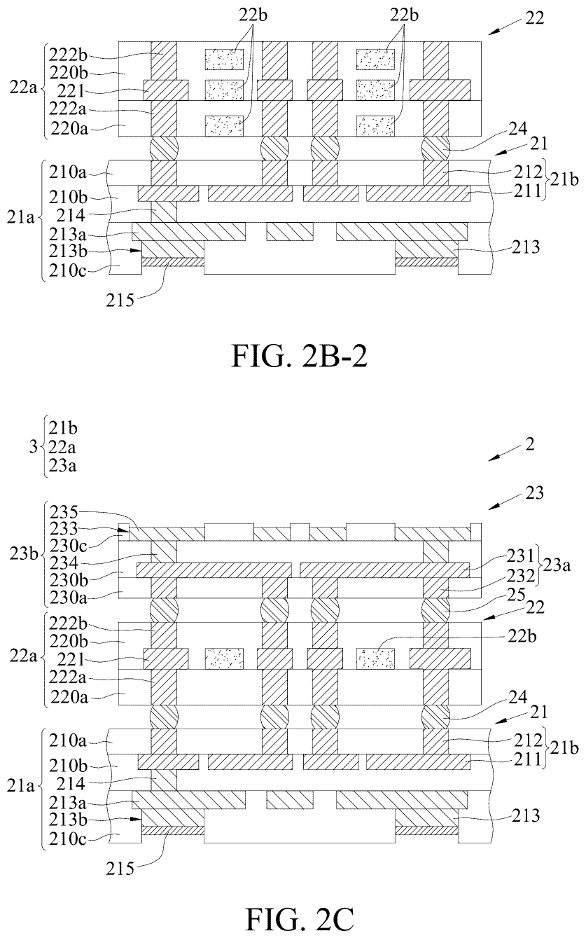

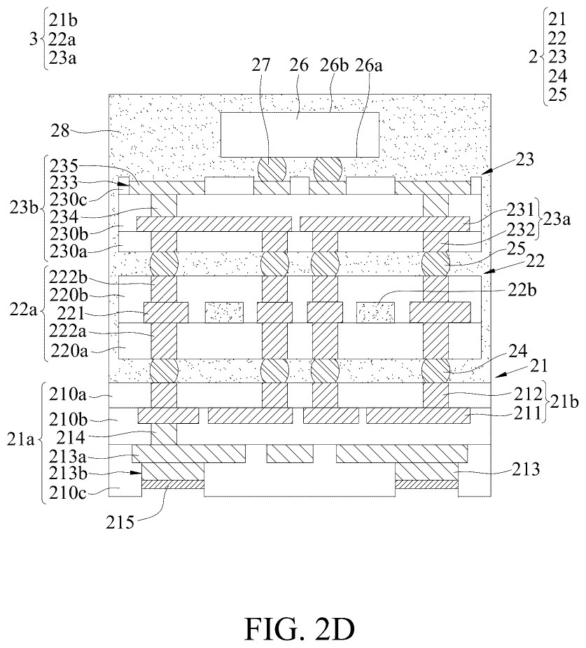

FIG. 2A, FIG. 2B-1, FIG. 2C and FIG. 2D are schematic cross-sectional views illustrating a manufacturing method of an inductor structure 2 according to a first embodiment of the present disclosure.

As shown in FIG. 2A, a bottom element 21 is provided. The bottom element 21 includes a first circuit structure 21a and a first inductance circuit portion 21b disposed on the first circuit structure 21a.

In an embodiment, the bottom element 21 can be manufactured by using a carrier board process, such as providing a carrier board having a metal surface on which the first inductance circuit portion 21b and the first circuit structure 21a are formed by a patterned manufacturing method. The carrier board is a separable metal board or a copper foil substrate, but not limited thereto, and this embodiment is illustrated by a metal board having a separable and copper-containing metal material on both sides thereof.

Moreover, the first inductance circuit portion 21b and the first circuit structure 21a can be manufactured by electroplating, sputtering, physical vapor deposition (PVD), or other methods. The first inductance circuit portion 21b includes at least one first inductance layer 211 and a plurality of pillar-shaped first inductance layers 212. The first circuit structure 21a includes first dielectric layers 210a, 210b, 210c, at least one first circuit layer 213a, 213b and a plurality of pillar-shaped first circuit layers 214. The first inductance circuit portion 21b is embedded in the first dielectric layers 210a, 210b.

For example, a plurality of pillar-shaped first inductance layers 212 made of copper material are firstly formed on a carrier board, and then a first dielectric layer 210a is formed on the carrier board to cover the plurality of pillar-shaped first inductance layers 212, and the pillar-shaped first inductance layers 212 are exposed from the first dielectric layer 210a. Subsequently, a first inductance layer 211 made of copper material is formed on the first dielectric layer 210a to be electrically connected to the pillar-shaped first inductance layers 212, and a plurality of pillar-shaped first circuit layers 214 made of copper material are formed on the first inductance layer 211. After that, a first dielectric layer 210b is formed on the first dielectric layer 210a to cover the first inductance layer 211 and the plurality of pillar-shaped first circuit layers 214, and the plurality of pillar-shaped first circuit layers 214 are exposed from the first dielectric layer 210b. Next, a first circuit layer 213a made of copper material is formed on the first dielectric layer 210b, and the first circuit layer 213a is in contact with the exposed surfaces of the plurality of pillar-shaped first circuit layers 214. Subsequently, a first circuit layer 213b having a plurality of bonding pads 213 is formed on the first circuit layer 213a, such that the positions of the plurality of bonding pads 213 correspond to the positions of the pillar-shaped first circuit layers 214. After that, a first dielectric layer 210c is formed on the first dielectric layer 210b to cover the first circuit layers 213a, 213b and the bonding pads 213, such that openings in the first dielectric layer 210c are formed to expose the bonding pads 213, and a surface treatment layer 215 can be formed on the exposed surfaces of the bonding pads 213. Finally, the carrier board is removed to expose the plurality of pillar-shaped first inductance layers 212. Thereafter, the bottom element 21 equivalent to that shown in FIG. 2A is obtained by flipping.

It should be understood that in the above embodiment, the plurality of pillar-shaped first inductance layers 212 are firstly formed on the carrier board, and then the first inductance layer 211, the plurality of pillar-shaped first circuit layers 214 and the first circuit layers 213a, 213b are sequentially formed and stacked thereon, but the present disclosure is not limited to the above embodiment. Alternatively, the first circuit layer 213b may be firstly formed on the carrier board, and then the first circuit layer 213a, the plurality of pillar-shaped first circuit layers 214, the first inductance layer 211 and the plurality of pillar-shaped first inductance layers 212 are sequentially formed and stacked thereon.

In an embodiment, the first dielectric layers 210a, 210b, 210c are used as insulators, and the materials thereof are photosensitive or non-photosensitive insulating materials, such as Ajinomoto build-up film (ABF), photosensitive resin, polyimide (PI), bismaleimide triazine (BT), flame resistant 5 (FR5) prepreg (PP), molding compound, or epoxy molding compound (EMC).

In an embodiment, the material of the surface treatment layer 215 is nickel/gold (Ni/Au), nickel/palladium/gold (Ni/Pd/Au), solder material, organic solderability preservative (OSP), or anti-oxidation agent (anti-tarnish agent).

As shown in FIG. 2B-1, an intermediate element 22 is stacked on the bottom element 21 by means of a plurality of first conductive structures 24. The intermediate element 22 includes at least one second inductance circuit portion 22a and at least one magnetically permeable body 22b. In an embodiment, the first conductive structures 24 are first conductive bumps. Each of the first conductive bumps is a copper paste bump, a silver paste bump, or a tin paste bump formed by coating, dispensing, or printing.

In an embodiment, the intermediate element 22 can be manufactured by using a carrier board process, such as providing a carrier board having a metal surface on which a plurality of pillar-shaped second inductance layers 222a of the second inductance circuit portion 22a are formed by a patterned manufacturing method. The carrier board is a separable metal board or a copper foil substrate, but not limited thereto, and this embodiment is illustrated by a metal board having a separable and copper-containing metal material on both sides thereof.

Moreover, the second inductance circuit portion 22a and the magnetically permeable body 22b can be manufactured by electroplating, sputtering, physical vapor deposition (PVD), or other methods. The second inductance circuit portion 22a includes at least one second inductance layer 221, a plurality of pillar-shaped second inductance layers 222a, 222b and second dielectric layers 220a, 220b. The magnetically permeable body 22b is embedded in the second dielectric layer 220b.

For example, a plurality of pillar-shaped second inductance layers 222a made of copper material are firstly formed on the carrier board, and then a second dielectric layer 220a is formed on the carrier board to cover the plurality of pillar-shaped second inductance layers 222a, and the pillar-shaped second inductance layers 222a are exposed from the second dielectric layer 220a. Subsequently, a second inductance layer 221 made of copper material is formed on the second dielectric layer 220a to be electrically connected to the pillar-shaped second inductance layers 222a, and a plurality of pillar-shaped second inductance layers 222b made of copper material are formed on the second inductance layer 221, and the magnetically permeable body 22b is disposed on the second dielectric layer 220a. After that, a second dielectric layer 220b is formed on the second dielectric layer 220a to cover the second inductance layer 221, the plurality of pillar-shaped second inductance layers 222b and the magnetically permeable body 22b, and the plurality of pillar-shaped second inductance layers 222b are exposed from the second dielectric layer 220b. The magnetically permeable body 22b is not electrically connected to the second inductance layer 221 and the plurality of pillar-shaped second inductance layers 222a, 222b. Finally, the carrier board is removed to expose the plurality of pillar-shaped second inductance layers 222a. Thereafter, the intermediate element 22 equivalent to that shown in FIG. 2B-1 is obtained by a singulation process.

In an embodiment, the plurality of first conductive structures 24 can be formed

on the plurality of pillar-shaped second inductance layers 222a or the plurality of pillar-shaped first inductance layers 212, and then at least one or more intermediate elements 22 are disposed on the bottom element 21 by means of the plurality of first conductive structures 24, such that the plurality of pillar-shaped second inductance layers 222a are electrically connected to the plurality of pillar-shaped first inductance layers 212 by means of the plurality of first conductive structures 24.

In an embodiment, the magnetically permeable body 22b is a magnetic conductive material such as at least one of iron (Fe), nickel (Ni), cobalt (Co), manganese (Mn), zinc (Zn) or a combination thereof, or an alloy metal such as NiFe, CoNiFe, and the like.

In an embodiment, the second dielectric layers 220a, 220b are used as insulators, and the materials thereof are photosensitive or non-photosensitive insulating materials, such as Ajinomoto build-up film (ABF), photosensitive resin, polyimide (PI), bismaleimide triazine (BT), flame resistant 5 (FR5) prepreg (PP), molding compound, or epoxy molding compound (EMC).

As shown in FIG. 2C, a top element 23 is stacked on the intermediate element 22 by means of a plurality of second conductive structures 25. The top element 23 includes a third inductance circuit portion 23a and a second circuit structure 23b disposed on the third inductance circuit portion 23a; accordingly, the inductor structure 2 of the present disclosure is obtained. In an embodiment, each of the second conductive structures 25 is a second conductive bump, and the second conductive bump is a copper paste bump, a silver paste bump, or a tin paste bump formed by coating, dispensing, or printing.

In an embodiment, the top element 23 can be manufactured by using a carrier board process, such as providing a carrier board having a metal surface on which the third inductance circuit portion 23a and the second circuit structure 23b are formed by a patterned manufacturing method. The carrier board is a separable metal board or a copper foil substrate, but not limited thereto, and this embodiment is illustrated by a metal board having a separable and copper-containing metal material on both sides thereof.

Moreover, the third inductance circuit portion 23a and the second circuit structure 23b can be manufactured by electroplating, sputtering, physical vapor deposition (PVD), or other methods. The third inductance circuit portion 23a includes at least one third inductance layer 231 and a plurality of pillar-shaped third inductance layers 232. The second circuit structure 23b includes third dielectric layers 230a, 230b, 230c, a second circuit layer 233 and a plurality of pillar-shaped second circuit layers 234. The third inductance circuit portion 23a is embedded in the third dielectric layers 230a, 230b.

For example, a plurality of pillar-shaped third inductance layers 232 made of copper material are firstly formed on the carrier board, and then a third dielectric layer 230a is formed on the carrier board to cover the plurality of pillar-shaped third inductance layers 232, and the pillar-shaped third inductance layers 232 are exposed from the third dielectric layer 230a. Subsequently, a third inductance layer 231 made of copper material is formed on the third dielectric layer 230a to be electrically connected to the pillar-shaped third inductance layers 232, and a plurality of pillar-shaped second circuit layers 234 made of copper material are formed on the third inductance layer 231, and then the third dielectric layer 230b is formed on the third dielectric layer 230a to cover the third inductance layer 231 and the plurality of pillar-shaped second circuit layers 234, and the plurality of pillar-shaped second circuit layers 234 are exposed from the third dielectric layer 230b. Next, a second circuit layer 233 made of copper material is formed on the third dielectric layer 230b, and the second circuit layer 233 is in contact with the exposed surfaces of the plurality of pillar-shaped second circuit layers 234. Subsequently, a third dielectric layer 230c is formed on the third dielectric layer 230b to cover the second circuit layer 233, such that openings in the third dielectric layer 230c are formed to expose the second circuit layer 233, and the exposed second circuit layer 233 can be used as electrode pads 235. Finally, the carrier board is removed to expose the electrode pads 235. Thereafter, the top element 23 equivalent to that shown in FIG. 2C is obtained by a singulation process.

It should be understood that in the above embodiment, the plurality of pillar-shaped third inductance layers 232 are firstly formed on the carrier board, and then the third inductance layer 231, the plurality of pillar-shaped second circuit layers 234 and the second circuit layer 233 are sequentially formed and stacked thereon, but the present disclosure is not limited to the above embodiment. Alternatively, the second circuit layer 233 may be firstly formed on the carrier board, and then the plurality of pillar-shaped second circuit layers 234, the third inductance layer 231 and the plurality of pillar-shaped third inductance layers 232 are sequentially formed and stacked thereon.

In an embodiment, the plurality of second conductive structures 25 can be firstly formed on the plurality of pillar-shaped second inductance layers 222b or the plurality of pillar-shaped third inductance layers 232, and then at least one top element 23 is correspondingly disposed on at least one intermediate element 22 by means of the plurality of second conductive structures 25, such that the plurality of pillar-shaped third inductance layers 232 are electrically connected to the plurality of pillar-shaped second inductance layers 222b by means of the plurality of second conductive structures 25.

In an embodiment, the third dielectric layers 230a, 230b, 230c are used as insulators, and the materials thereof are photosensitive or non-photosensitive insulating materials, such as Ajinomoto build-up film (ABF), photosensitive resin, polyimide (PI), bismaleimide triazine (BT), flame resistant 5 (FR5) prepreg (PP), molding compound, or epoxy molding compound (EMC).

In a subsequent process, the inductor structure 2 of the present disclosure can be subjected to a semiconductor packaging process. As shown in FIG. 2D, a semiconductor package can be accomplished by electrically bonding an electronic element 26 to the electrode pads 235. The electronic element 26 can be an active element or a passive element. In an embodiment, the active element is a semiconductor chip having an active surface 26a and an inactive surface 26b opposite to the active surface 26a. The electronic element 26 is bonded to the electrode pads 235 in a flip-chip manner via a plurality of solder bumps 27 bonded with the active surface 26a.

Further, a package layer 28 is formed on the bottom element 21 to cover the intermediate element 22, the top element 23, the electronic element 26, the plurality of first conductive structures 24 and the plurality of second conductive structures 25 and to fill in between any two of the intermediate elements 22 and between any two of the top elements 23. Thereafter, a singulation process can be performed from the bottom element 21 along the package layer 28 between any two of the intermediate elements 22 and between any two of the top elements 23 to obtain a semiconductor package structure incorporating the inductor structure 2 as shown in FIG. 2D.

In an embodiment, the first inductance circuit portion 21b, the second inductance circuit portion 22a and the third inductance circuit portion 23a constitute an inductance coil 3, and the inductance coil 3 is a toroidal solenoid coil, a solenoid coil (vertical type or horizontal type) and surrounds the magnetically permeable body 22b, such that the magnetically permeable body 22b is located within the inductance coil 3 and is not electrically connected to the inductance coil 3, the first circuit structure 21a and the second circuit structure 23b. Further, the contact points of the third inductance layer 231 and the plurality of pillar-shaped second circuit layers 234 can serve as input and output ports of the inductance coil 3.

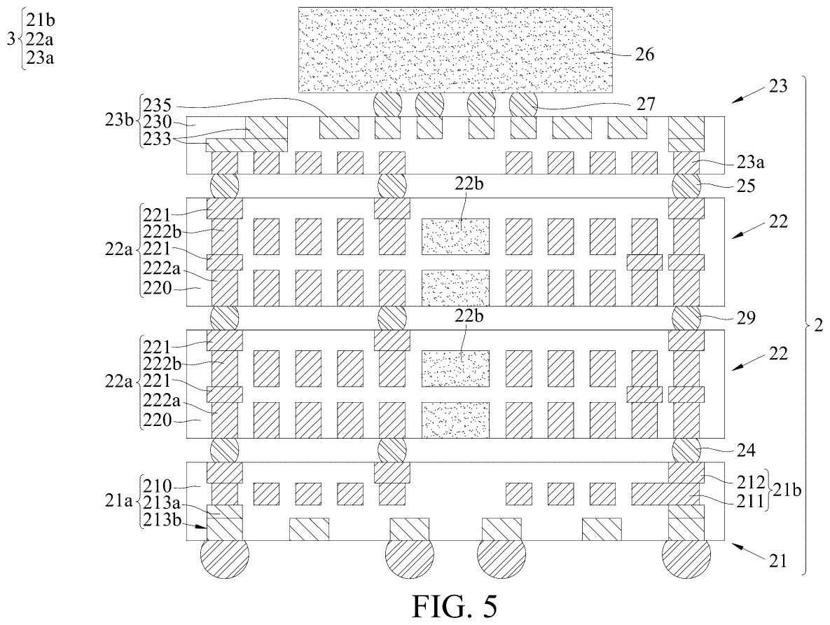

In other embodiments, as shown in FIG. 5, the first inductance circuit portion 21b, the second inductance circuit portion 22a and the third inductance circuit portion 23a may be a single-layer planar spiral coil, and the second inductance circuit portion 22a may be designed in a multi-layer configuration according to the demand, and the layers are electrically connected by the second inductance layer 221. The first inductance circuit portion 21b, the second inductance circuit portion 22a and the third inductance circuit portion 23a constitute an inductance coil 3, such that the inductance coil 3 is a multi-layered planar spiral coil and surrounds the magnetically permeable body 22b, such that the magnetically permeable body 22b is located within the inductance coil 3 and is not electrically connected to the inductance coil 3, the first circuit structure 21a and the second circuit structure 23b.

In an embodiment, instead of forming an underfill between the electronic element 26 and the top element 23, a package layer 28 is formed directly to cover the plurality of solder bumps 27. In other embodiments, an underfill may be firstly formed between the electronic element 26 and the top element 23 to cover the plurality of solder bumps 27, and a package layer 28 is subsequently formed.

The above embodiment is illustrated by a single intermediate element 22 having one layer of the magnetically permeable body 22b, but the present disclosure is not limited to the above embodiment. The number of layers of the magnetically permeable body 22b in a single intermediate element 22 may be designed according to the size of the desired inductance value. As shown in FIG. 2B-2, the magnetically permeable body 22b can be stacked in multiple layers to provide higher inductance values and Q values (where Q stands for quality or quality factor) and to better meet the demands of a higher frequency usage environment. In addition, a plurality of intermediate elements 22 can be stacked between the bottom element 21 and the top element 23. As shown in FIG. 5, the intermediate elements 22 can be electrically connected to each other by third conductive structures 29. Each of the third conductive structures 29 is a third conductive bump, and the third conductive bump is a copper paste bump, a silver paste bump, or a tin paste bump formed by coating, dispensing, or printing.

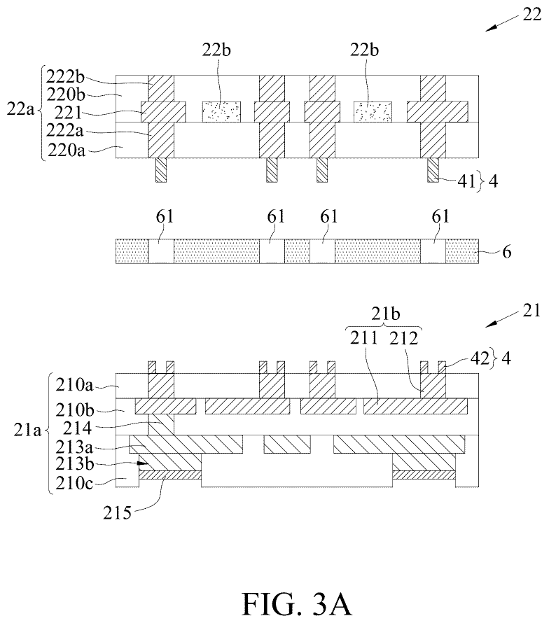

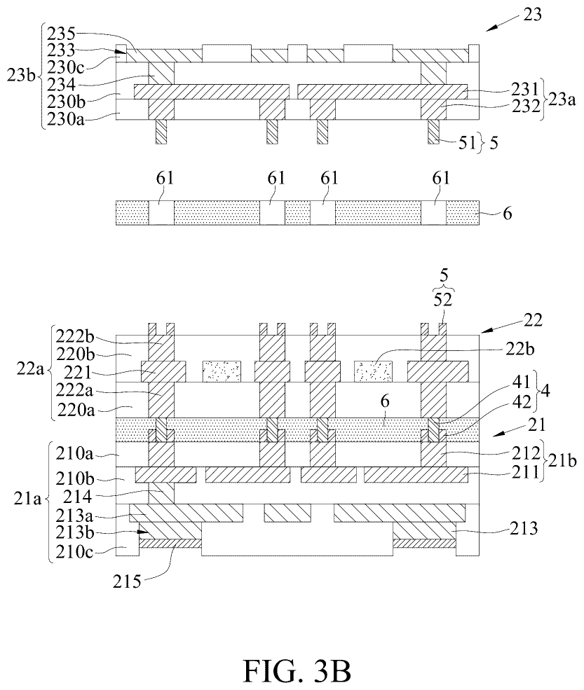

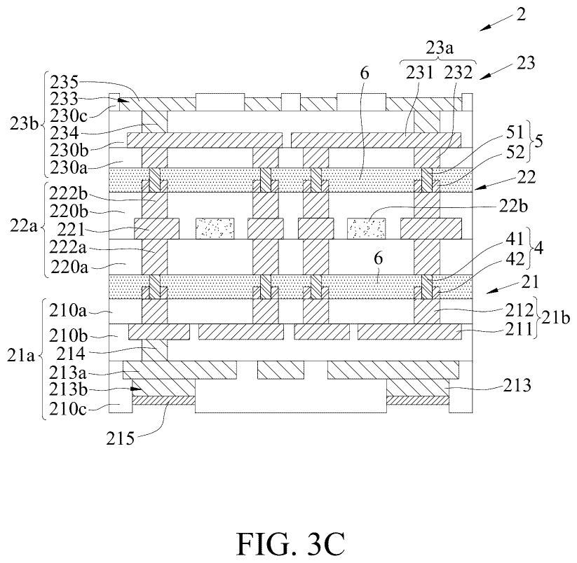

FIG. 3A, FIG. 3B and FIG. 3C are schematic cross-sectional views of the inductor structure 2 according to the second embodiment of the present disclosure. The second embodiment differs from the first embodiment in that first conductive structures 4, second conductive structures 5 and insulating adhesive films 6 are used instead of the first conductive structures 24 and the second conductive structures 25. Each of the first conductive structures 4 has a first male member 41 and a first female member 42, and each of the second conductive structures 5 has a second male member 51 and a second female member 52. Only the differences are described hereinafter, and the same technical contents will not be repeated herein.

As shown in FIG. 3A, a plurality of first male members 41 (e.g., copper pillars or tin pillars) are formed on the plurality of pillar-shaped second inductance layers 222a, and a plurality of first female members 42 (e.g., copper rings or tin rings) are formed on the plurality of pillar-shaped first inductance layers 212. The plurality of first male members 41 are matched with the plurality of first female members 42.

Before assembling the bottom element 21 and the intermediate element 22, an insulating adhesive film 6 can be perforated, for example, by laser, to form a plurality of vias 61, and the insulating adhesive film 6 is disposed between the bottom element 21 and the intermediate element 22 in such a way that the vias 61 are aligned with the first male members 41 and the first female members 42. Next, a pressing process is carried out to bond the bottom element 21 and the intermediate element 22 and to enable the first male members 41 and the first female members 42 to be contacted and connected.

As shown in FIG. 3B, a plurality of second male members 51 (e.g., copper pillars or tin pillars) are formed on the plurality of pillar-shaped third inductance layers 232, and a plurality of second female members 52 (e.g., copper rings or tin rings) are formed on the plurality of pillar-shaped second inductance layers 222b. The plurality of second male members 51 are matched with the plurality of second female members 52.

Before assembling the top element 23 on the intermediate element 22, the insulating adhesive film 6 having the plurality of vias 61 can be disposed between the intermediate element 22 and the top element 23, and the vias 61 are aligned with the second male members 51 and the second female members 52. Subsequently, a pressing process is performed to bond the top element 23 to the intermediate element 22 and to enable the second male members 51 and the second female members 52 to be contacted and connected, so as to obtain the inductor structure 2 as shown in FIG. 3C.

In an embodiment, the insulating adhesive film 6 can be made of ABF, photosensitive resin, PI, BT, PP, molded resin, EMC, or other materials.

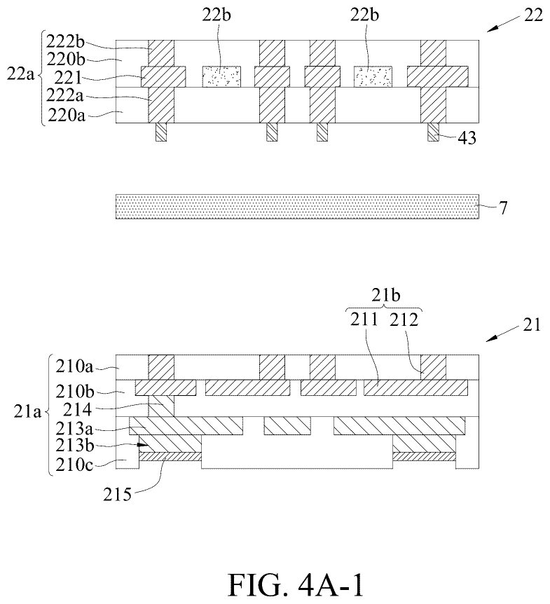

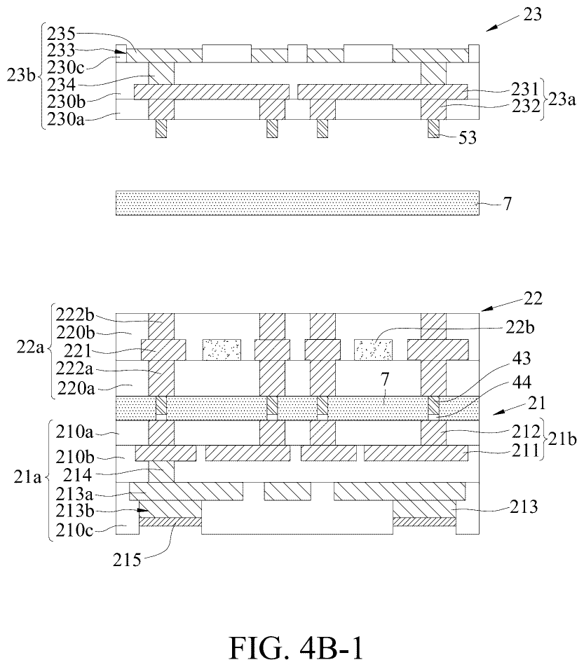

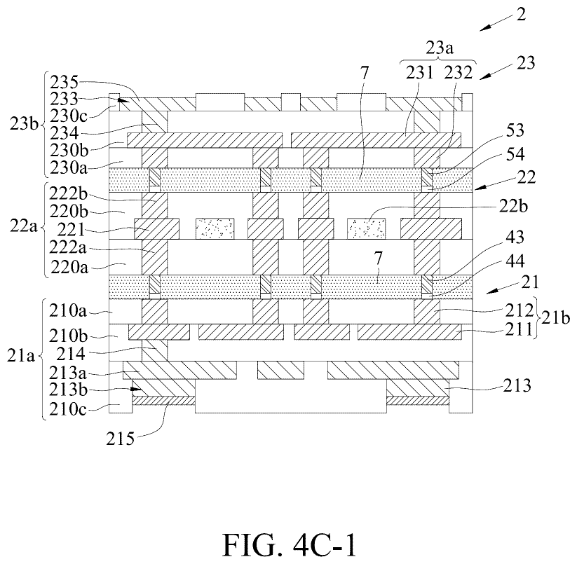

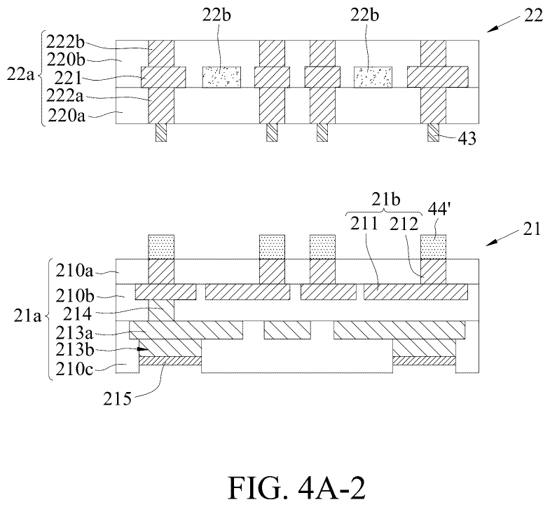

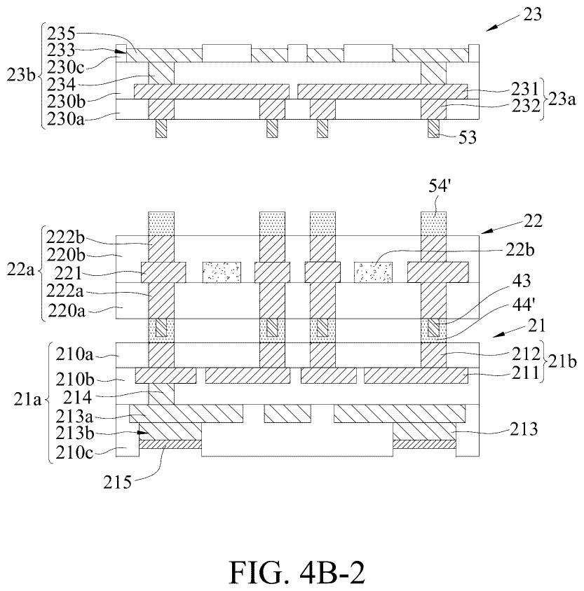

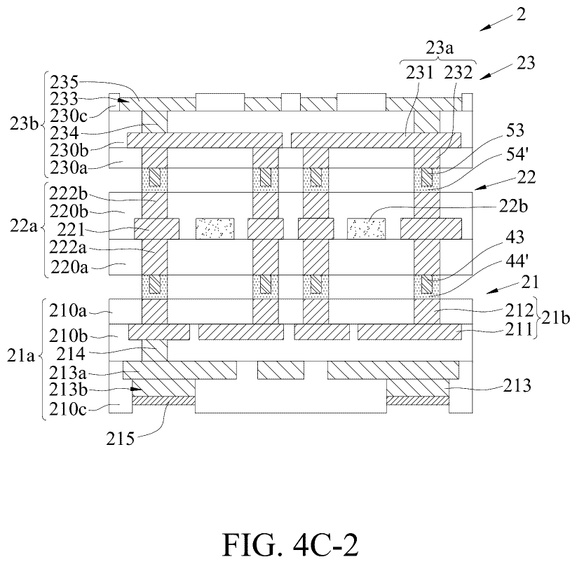

FIG. 4A-1, FIG. 4B-1 and FIG. 4C-1 are schematic cross-sectional views of the inductor structure 2 according to the third embodiment of the present disclosure. The third embodiment differs from the aforementioned second embodiment in that first conductive structures 4, second conductive structures 5 and anisotropic conductive films (ACFs) 7 are used instead of the insulating adhesive films 6. Each of the first conductive structures 4 has a first conductive pillar 43 and a first conductor 44 that is matched with the first conductive pillar 43, and each of the second conductive structures 5 has a second conductive pillar 53 and a second conductor 54 that is matched with the second conductive pillar 53. Only the differences are described hereinafter, and the same technical contents will not be repeated herein.

As shown in FIG. 4A-1, a plurality of first conductive pillars 43 (e.g., copper pillars or tin pillars) are formed on the plurality of pillar-shaped second inductance layers 222a. An anisotropic conductive film 7 can be disposed between the first dielectric layer 210a of the bottom element 21 and the second dielectric layer 220a of the intermediate element 22 before the bottom element 21 and the intermediate element 22 are assembled with each other. Subsequently, the anisotropic conductive film 7 is pressurized by the plurality of first conductive pillars 43 in a press-fit manner. Due to the characteristics of the anisotropic conductive film 7, portions of the anisotropic conductive film 7 that are pressed against the plurality of first conductive pillars 43 will form conductors that conduct, and therefore said portions of the anisotropic conductive film 7 can be used as first conductors 44 that are electrically conductive to the first conductive pillars 43 (as shown in FIG. 4B-1), while the other portions of the anisotropic conductive film 7 that are not pressed against the first conductive pillars 43 form an unconductive insulating layer and can be used to enable the bottom element 21 and the intermediate element 22 to be simultaneously glued together by pressing the anisotropic conductive film 7.

As shown in FIG. 4B-1, a plurality of second conductive pillars 53 (e.g., copper pillars or tin pillars) are formed on the plurality of pillar-shaped third inductance layers 232. The anisotropic conductive film 7 can be disposed between the second dielectric layer 220b of the intermediate element 22 and the third dielectric layer 230a of the top element 23 before the top element 23 is assembled on the intermediate element 22. Subsequently, the anisotropic conductive film 7 is pressurized by the plurality of second conductive pillars 53 in a press-fit manner, such that portions of the anisotropic conductive film 7 that are pressed against the plurality of second conductive pillars 53 will form conductors that conduct, and therefore said portions of the anisotropic conductive film 7 can be used as second conductors 54 that are electrically conductive to the second conductive pillars 53 (as shown in FIG. 4C-1), while the other portions of the anisotropic conductive film 7 that are not pressed against the second conductive pillars 53 form an unconductive insulating layer and can be used to enable the intermediate element 22 and the top element 23 to be simultaneously glued together by pressing the anisotropic conductive film 7. Accordingly, the inductor structure 2 as shown in FIG. 4C-1 can be obtained.

In other embodiments, as shown in FIG. 4A-2, instead of using the anisotropic conductive film 7, a plurality of first conductors 44′ (e.g., anisotropic conductive paste [ACP] bumps, copper paste bumps, tin paste bumps, or silver paste bumps) are formed on the plurality of pillar-shaped first inductance layers 212 by coating, dispensing, or printing. In addition, each of the first conductive pillars 43 is embedded in each of the first conductors 44′ by pressing, such that each of the first conductive pillars 43 is electrically connected to each of the first conductors 44′ and integrated as a single unit. The first conductive pillars 43 and the first conductors 44′ are the first conductive structures 4.

Subsequently, as shown in FIG. 4B-2, a plurality of second conductors 54′ (e.g., anisotropic conductive paste bumps, copper paste bumps, tin paste bumps, or silver paste bumps) are formed on the plurality of pillar-shaped second inductance layers 222b by means of coating, dispensing, or printing, and each of the second conductive pillars 53 is embedded in each of the second conductors 54′ by pressing, such that each of the second conductive pillars 53 is electrically connected to each of the second conductors 54′ and integrated as a single unit. The second conductive pillars 53 and the second conductors 54′ are the second conductive structures 5, whereby the inductor structure 2 shown in FIG. 4C-2 can be obtained.

In summary, in the inductor structure of the present disclosure and the method thereof, the bottom element, the intermediate element and the top element can be manufactured respectively by the carrier board process, or even by different production lines, in order to carry out the mass production of large boards easily, and then the different bottom elements, intermediate elements and top elements can be assembled by the packaging method to accomplish a complete inductor structure. Therefore, the inductor structure of the present disclosure and the manufacturing method thereof can satisfy the demand of different inductance values by assembling and stacking, and the manufacturing time and cost can be effectively shortened and reduced.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. An inductor structure, comprising:
a bottom element including a first circuit structure and a first inductance circuit portion disposed on the first circuit structure;
at least one intermediate element stacked on the bottom element and including at least one second inductance circuit portion and at least one magnetically permeable body, wherein the second inductance circuit portion is electrically connected to the first inductance circuit portion; and
a top element stacked on the intermediate element and including a third inductance circuit portion and a second circuit structure disposed on the third inductance circuit portion, wherein the third inductance circuit portion is electrically connected to the second inductance circuit portion,
wherein a plurality of first conductive structures are bonded between the first inductance circuit portion and the second inductance circuit portion, the second inductance circuit portion is electrically connected to the first inductance circuit portion by the plurality of first conductive structures, a plurality of second conductive structures are interposed between the second inductance circuit portion and the third inductance circuit portion, the third inductance circuit portion is electrically connected to the second inductance circuit portion by the plurality of second conductive structures, the first inductance circuit portion, the second inductance circuit portion and the third inductance circuit portion constitute an inductance coil, and the magnetically permeable body is located within the inductance coil and is free from being electrically connected to the inductance coil, the first circuit structure and the second circuit structure.

2. The inductor structure of claim 1, wherein each of the plurality of first conductive structures is a first conductive bump, and each of the plurality of second conductive structures is a second conductive bump.

3. The inductor structure of claim 2, wherein the first conductive bump and the second conductive bump are copper paste bumps, tin paste bumps, or silver paste bumps.

4. The inductor structure of claim 1, wherein each of the plurality of first conductive structures has a first male member and a first female member that is matched with the first male member, one of the first male member and the first female member is bonded with the first inductance circuit portion, the other one of the first male member and the first female member is bonded with the second inductance circuit portion, each of the plurality of second conductive structures has a second male member and a second female member that is matched with the second male member, one of the second male member and the second female member is bonded with the second inductance circuit portion, and the other one of the second male member and the second female member is bonded with the third inductance circuit portion.

5. The inductor structure of claim 4, wherein the first male member and the second male member are copper pillars or tin pillars, and the first female member and the second female member are copper rings or tin rings.

6. The inductor structure of claim 4, further comprising an insulating adhesive film disposed between the bottom element and the intermediate element and disposed between the intermediate element and the top element, wherein the insulating adhesive film has a plurality of vias to accommodate the plurality of first conductive structures and the plurality of second conductive structures.

7. The inductor structure of claim 1, wherein each of the plurality of first conductive structures has a first conductive pillar and a first conductor that is matched with the first conductive pillar, one of the first conductive pillar and the first conductor is bonded with the first inductance circuit portion, the other one of the first conductive pillar and the first conductor is bonded with the second inductance circuit portion, each of the plurality of second conductive structures has a second conductive pillar and a second conductor that is matched with the second conductive pillar, one of the second conductive pillar and the second conductor is bonded with the second inductance circuit portion, and the other one of the second conductive pillar and the second conductor is bonded with the third inductance circuit portion.

8. The inductor structure of claim 7, wherein the first conductive pillar and the second conductive pillar are copper pillars or tin pillars, and the first conductor and the second conductor are anisotropic conductive films, anisotropic conductive paste bumps, copper paste bumps, tin paste bumps, or silver paste bumps.

9. The inductor structure of claim 1, wherein the magnetically permeable body is structured in a single layer or in multiple layers in a separated stack.

10. The inductor structure of claim 1, wherein the inductance coil is a toroidal solenoid coil, a solenoid coil, or a planar spiral coil.

11. The inductor structure of claim 1, further comprising an electronic element disposed on the second circuit structure.

12. The inductor structure of claim 11, further comprising a package layer formed on the bottom element and covering the intermediate element, the top element and the electronic element.

13. A method of manufacturing an inductor structure, the method comprising:
providing a bottom element, wherein the bottom element includes a first circuit structure and a first inductance circuit portion disposed on the first circuit structure;
stacking and bonding an intermediate element on the bottom element, wherein the intermediate element includes at least one second inductance circuit portion and at least one magnetically permeable body, and the second inductance circuit portion is electrically connected to the first inductance circuit portion; and
stacking and bonding a top element on the intermediate element, wherein the top element includes a third inductance circuit portion and a second circuit structure disposed on the third inductance circuit portion, the third inductance circuit portion is electrically connected to the second inductance circuit portion, the first inductance circuit portion, the second inductance circuit portion and the third inductance circuit portion constitute an inductance coil, and the magnetically permeable body is located within the inductance coil and is free from being electrically connected to the inductance coil, the first circuit structure and the second circuit structure.

14. The method of claim 13, further comprising forming a plurality of first conductive bumps between the first inductance circuit portion and the second inductance circuit portion, wherein the second inductance circuit portion is electrically connected to the first inductance circuit portion by the plurality of first conductive bumps; and forming a plurality of second conductive bumps between the second inductance circuit portion and the third inductance circuit portion, wherein the third inductance circuit portion is electrically connected to the second inductance circuit portion by the plurality of second conductive bumps.

15. The method of claim 14, wherein the plurality of first conductive bumps and the plurality of second conductive bumps are copper paste bumps, tin paste bumps, or silver paste bumps formed by coating, dispensing, or printing.

16. The method of claim 13, further comprising forming an insulating adhesive film between the first inductance circuit portion and the second inductance circuit portion and between the second inductance circuit portion and the third inductance circuit portion, wherein a plurality of first conductive structures are provided between the first inductance circuit portion and the second inductance circuit portion, the second inductance circuit portion is electrically connected to the first inductance circuit portion by the plurality of first conductive structures, a plurality of second conductive structures are provided between the second inductance circuit portion and the third inductance circuit portion, and the third inductance circuit portion is electrically connected to the second inductance circuit portion by the plurality of second conductive structures, wherein the insulating adhesive film has a plurality of vias to accommodate the plurality of first conductive structures and the plurality of second conductive structures respectively.

17. The method of claim 16, wherein each of the plurality of first conductive structures has a first male member and a first female member that is matched with the first male member, one of the first male member and the first female member is provided on the first inductance circuit portion, the other one of the first male member and the first female member is provided on the second inductance circuit portion, each of the plurality of second conductive structures has a second male member and a second female member that is matched with the second male member, one of the second male member and the second female member is provided on the second inductance circuit portion, and the other one of the second male member and the second female member is provided on the third inductance circuit portion.

18. The method of claim 17, wherein the first male member and the second male member are copper pillars or tin pillars, and the first female member and the second female member are copper rings or tin rings.

19. The method of claim 13, further comprising forming a plurality of first conductors between the bottom element and the intermediate element; and forming a plurality of second conductors between the intermediate element and the top element, wherein a bottom surface of the second inductance circuit portion or a top surface of the first inductance circuit portion has a plurality of first conductive pillars that are matched with the plurality of first conductors, and a bottom surface of the third inductance circuit portion or a top surface of the second inductance circuit portion has a plurality of second conductive pillars that are matched with the plurality of second conductors.

20. The method of claim 19, wherein the plurality of first conductors and the plurality of second conductors are laminated anisotropic conductive films, or the plurality of first conductors and the plurality of second conductors are anisotropic conductive paste bumps, copper paste bumps, tin paste bumps, or silver paste bumps formed by coating, dispensing, or printing, and the plurality of first conductive pillars and the plurality of second conductive pillars are copper pillars or tin pillars.

21. The method of claim 13, wherein the magnetically permeable body is structured in a single layer or in multiple layers in a separated stack.

22. The method of claim 13, wherein the inductance coil is a toroidal solenoid coil, a solenoid coil, or a planar spiral coil.

23. The method of claim 13, further comprising disposing at least one electronic element on the second circuit structure.

24. The method of claim 23, further comprising forming a package layer on the bottom element to cover the intermediate element, the top element and the electronic element.
